(19) United States
(12) Patent Application Publication
(10) Pub. No.: US 2010/0274650 A1
(43) Pub. Date: Oct. 28, 2010

(54) REFERRAL-BASED LOYALTY PROGRAM

(75) Inventors: Joel R. Kantor, San Diego, CA (US); Larry Kantor, San Diego, CA (US)

Correspondence Address: Nixon Peabody LLP, P.O. Box 60610, Palo Alto, CA, 94306, US

(73) Assignee: Synergy World, Inc., San Diego, CA (US)

(21) Appl. No.: 12/761,373

(22) Filed: Apr. 15, 2010

Related U.S. Application Data
(60) Provisional application No. 61/170,552, filed on Apr. 17, 2009.

(51) Int. Cl. G06Q 30/00

(52) U.S. Cl. 705/14.16

(57) ABSTRACT

A referral-based loyalty program incentivizes referrals by awarding rewards to primary customers for transactions by secondary customers. The secondary customers receive primary-account-identifying information, such as by hyperlink, and navigate to an order page of a merchant to establish an account and implement a transaction, for which the primary customer receives an reward. Primary and secondary accounts can be linked with one another at the merchant premises, or online, and can be associated with physical cards carried by the customers and presented during transactions. Rewards can be made contingent upon registration and activation of accounts.

### STATEMENT OF PRIORITY

The present application claims priority to U.S. Provisional Patent Application Ser. No. 61/170,552, filed Apr. 17, 2009, the contents of which are incorporated herein by reference in their entirety.

### STATEMENT OF RELATED APPLICATION(S)

The present application may be considered related to pending U.S. patent application Ser. No. 11/395,885 filed Mar. 31, 2006, in the name of inventors Joel R. Kantor and Larry Kantor, entitled “TRACKING MERCHANT SPECIFIC REWARD CREDITS AND BALANCES IN A MULTI MERCHANT ENVIRONMENT UTILIZING ONE CARD OR ACCOUNT NUMBER,” commonly owned herewith.

### TECHNICAL FIELD

The present disclosure relates generally to loyalty programs for encouraging customers to patronize business establishments.

### BACKGROUND

Loyalty marketing is a vital and key strategy for companies trying to grow their business in a competitive marketplace. Customer loyalty has been stated by CEOs as their number one management challenge. It is well known that it costs more to acquire a new customer than to retain an existing one. A two percent increase in customer retention can earn the same profits as a ten percent reduction in operating costs. In addition, 20% of a merchant's customers can account for 80% of revenues, making it invaluable to implement a customer reward/retention program. The aims of loyalty programs generally include:
1. Acquiring new customers
2. Increasing frequency of visits
3. Motivating customers to increase their average spend
4. Increasing Customer Retention by developing customer appreciation and relationships
5. Customer advocacy

There are generally six types of common loyalty programs. The first of these is point-based rewards redeemed for prizes at individual merchants. Such a points-based reward program is designed for the individual merchant. The program rewards customers for their patronage, frequency of visits and level of spending by offering a point-based reward system. Customers receive points for dollars spent. The merchant determines the prize/reward to give away when the customer reaches certain point thresholds. When the reward is redeemed at the merchant, the merchant deducts points from the customer's account. The points and prizes are merchant-specific. In card-based implementations, this program is in the form of one card that is useable at one merchant. An example of a point rewarding schedule under this system is:
100 points, the customer receives a free T-shirt,
300 points, the customer receives a free dinner,
500 points, the customer receives two free diners.

A second type of common loyalty program is point-based rewards redeemed for cash back at individual merchants. This program is similar to the first type above, in which the customer earns and accumulates points for dollars spent. However, in this case, when the customer reaches a pre-determined point threshold, points are redeemed for cash back or a gift certificate that can be used at that merchant only. In this program, a single card is used at a single merchant. The following is an example:
100 points, the customer receives a $20 gift card at the originating merchant,
100 points, the customer receives a $20 gift certificate at the originating merchant,
100 points, the customer receives a $20 credit back onto their loyalty card with the originating merchant (limited to one card to be used only at that merchant).

A third type of program is a multi-merchant point-based reward program. This type is typically a global point program similar to a frequent flyer program. Consumers receive points for dollars spent at participating merchants, which are usually more than one in number. A participating customer in this program redeems his/her points from a global point redemption site, for example a website. Importantly, points are not tracked and redeemed per individual merchant. The following provides an example:
1000 points, customer receives free coffee maker,
5000 points, customer receives free stereo.

A fourth type of program is a multi-merchant cash back reward program. This type of program is usually implemented by large credit card companies, although it may also be implemented by private label debit card companies as well. When a participating cardholder uses a major credit card brand or a private label debit card in this program, the cardholder earns, instead of points, cash back on every transaction. This cash back can be returned to the customer any of the following ways:
a.) “Credited” back to the customer credit card, for example a la The Rewards Network™
b.) Donated to a fundraising organization—for example, E-Scrip and Fundraiser Rewards™
c.) Designated towards a savings or retirement account—for example, Upromise™
d.) Added back onto the private label Debit Card—for example, Creditz™

A fifth type of common loyalty program is a multi-merchant instant rewards and voucher program. This type of program is designed to give the customer immediate rewards, incentives and targeted vouchers printed at the checkout, and is not a conventional reward points program. Many grocery stores chains have immediate coupons/vouchers that print at the point of sale and are considered an example of this type of program.

A sixth type of common loyalty program is a show-and-save type program. Consumers in this case receive a plain wallet-sized card, typically of plastic or cardboard, often referred to as a discount card. It has no magnetic strip or other form of electronic information storage. The cardholder simply shows the card to the merchant, and receives a discount in return.

### OVERVIEW

As described herein, a method for implementing a referral-based loyalty program includes establishing a primary account, establishing a secondary account, storing information relating to the first and/or second account in a computer memory, linking the primary and secondary accounts, and crediting an award to the primary account based on a transaction involving the secondary account.

Further as described herein, a method for implementing a referral-based loyalty program includes conducting a first transaction with a primary customer, establishing a primary customer account using information exchanged during the first transaction, associating a first reward with the first transaction as a function of the first transaction, and crediting the first reward to the primary customer account and activating the primary customer account upon completion of a registration process.

Further as described herein, a server system for implementing a loyalty program includes a data store configured to store account information relating to a primary customer account associated with the primary customer, a transaction module configured to track a transaction between a secondary customer and a merchant, and a tabulation module configured to credit and/or debit the primary customer account with a first reward as a function of the transaction based on information identifying the primary customer account provided by the secondary customer.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is schematic diagram of a system for administering a referral-based loyalty program;

FIG. 2 is a block diagram showing details of a server system for implementing a referral-based loyalty program; and

FIGS. 3-7 are flow diagrams showing implantation of referral-based loyalty programs in accordance with various approaches.

### DESCRIPTION OF EXAMPLE EMBODIMENTS

Example embodiments are described herein in the context of a referral-based loyalty program. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

In a referral-based loyalty program as described herein, without limitation, three main players are involved. These are the merchant, the primary customer, and the secondary customer. In some arrangements as detailed below, a fourth player—a third party administrator of the loyalty program—may also be involved. The merchant is shorthand for a provider of goods or services, preferably but necessarily for consideration. The merchant may be an enterprise, for business and for profit or non-profit, or it may be an individual or a group of individuals, as in a franchise type of arrangement, for example. The goods or services may be for instance retail or wholesale sale of merchandise. The customer is the direct or indirect recipient of the goods or services. All or a portion of the transaction between the merchant and customer can take place via a physical, person-to-person transaction, an Internet transaction, mail-order, or any other form of exchange between parties. The exchange can take place at more than one location and over one or more interactions.

The referral-based loyalty program includes a core loyalty program in which one or more participating customers are incentivized to patronize one or more participating merchants to obtain goods or services from the merchant(s), possibly in exchange for some form of consideration, as defined above. Thus the core loyalty program can be in accordance to one (or a combination) of the six programs described above in the Background Section. For example, the participating customers receive credits for each transaction, or each set of transactions, that are of nominal value to them. In a specific, non-limiting example, a customer who patronizes a restaurant of a merchant can receive a credit for $0.10 for each $1.00 spent at the restaurant. This can be tabulated on a per-visit basis, or in the aggregate, over a period of time. Alternatively, incentivization can be based on the number of visits—that is, for each 5 visits, the customer is awarded a $10.00 credit, or is given free merchandise such as a t-shirt. Of course the merchant may have multiple establishments, and may wish to incentivize patronization of all or some of them, on an equal or weighted basis. Numerous variations on this type of incentivization are contemplated, in accordance with the well-known programs described above.

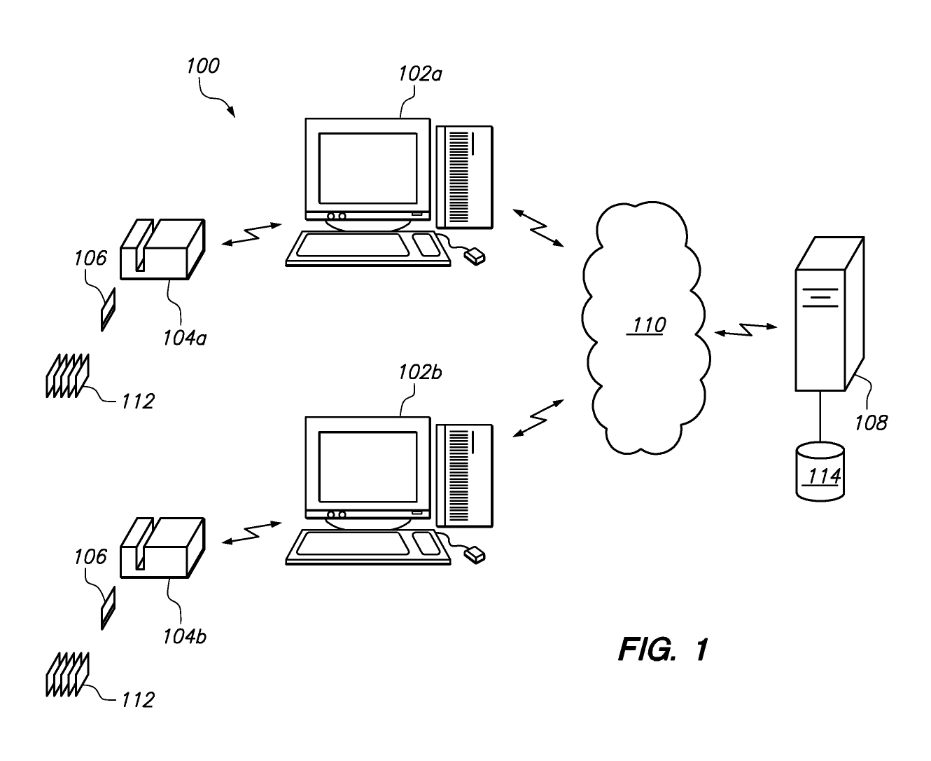

In terms of implementation, reference is made to FIG. 1, illustrating a system 100 for administering a loyalty program. In system 100, the operation of a merchant having two separate locations from which to transact business with customers is illustrated. Processing terminals 102a and 102b (102 collectively) are associated with each location. The merchant is shown as being provided with a single processing terminal at each location, but it will appreciated that multiple such terminals can be associated with each merchant location, and the multiple terminals, whether co-located or not, can be connected to and in communication with one another by way of one or more networks (LAN), VLAN, WAN, Internet, etc., which can be partly or in whole wired or wireless, in any known fashion. In addition, although discussed in terms of a single merchant, it is contemplated that the loyalty program can involve multiple merchants, as described in co-pending U.S. patent application Ser. No. 11/395,885, the contents of which are incorporated herein by reference in their entirety.

The processing terminals 102 can be separate personal computers (PCs), laptops, handheld devices, PDAs, etc., or they can be cash register type devices equipped with the necessary processing capabilities as detailed further below. Each merchant location is further provided with an information reading type device, designated 104a, 104b and referred to collectively as readers 104. The readers 104, which can be separate dedicated devices or integrated with the processing terminals 102, comprise automated information readers configured to interact with and read information from a customer-held storage medium, for example participant cards 106 held by customers patronizing the merchant. A typical type of such interaction is a swiping motion of a magnetic strip-bearing card 106 through the reader. Magnetic heads in the reader read (and optionally write) magnetically-stored information in the magnetic card. Information is stored in machine-readable format. Other types of information storage are well-known, and may or may not be disposed on a card-type medium. They include electronic information stored on semiconductor chips (smart cards), RFID (radio frequency identification) type storage, optical (for example, bar code) storage, and so forth. IVR (interactive voice response) can also be used, wherein information is entered over a telephone terminal using a touch-tone keypad, or by speaking into the telephone, and so on. A more generic designation of the reader 104 is a point-of-sale device, although the term “sale” is not intended to mean that an actual exchange of merchandise is necessary, as other transactions, including service transactions for instance, are contemplated.

The readers 104 are in communication with terminals 102, either wirelessly or by way of cables (not shown), and convey the information stored on the customer held storage media (participant cards 106) to the terminals. In turn, in one embodiment, each of the processing terminals 102 and/or readers 104 is in communication with a central server system 108 by way of any known network, for example the Internet, and/or telephone lines shown generally. Intermediate networks or subnets (not shown) may be present between the terminals 102 and central server system 108. Further, while central server system 108 is depicted as a single device, it will be recognized that it may comprise multiple devices having different or redundant functionality. For example, gateways, routers, proxy servers, server farms and data storage devices may all be part of the central server system 108 and configured to provide the functionality detailed herein. A data storage device 114 is shown as an example of a computer storage device for storing information relating to customer and merchant accounts. It will be appreciated that the use of intermediate terminals 102 is optional. In an alternative aspect, readers 104 communicate directly with central server system 108 by way of network 110, without the need for processing terminals 102. Such readers would have their own communication module for example, in the form of a wired or wireless modem, and so forth, as necessary to conduct the communication with central server system 108.

In accordance with one embodiment, central server system 108 is configured to track transactions between customers and merchants and to reward customers based on factors such as transaction frequency, transaction time and transaction size. The terminals 102 and/or central server 108 also conduct transaction authorization as necessary. To implement this functionality, central server system 108 maintains primary customer accounts, identified by unique account numbers that can be customer telephone numbers. In addition, central server system 108 can maintain merchant accounts to which various primary customer accounts can also be linked as necessary. The merchant accounts would also have their own unique identifiers and other information necessary to implement the awards program. Account information storage can be effected in database 114, which can store merchant and customer accounts, or which can be dedicated to merchant or customer accounts, with other databases (not shown) being provided for other accounts. In addition, additional servers (not shown) can be provided to implement retrieval and servicing of the various additional dedicated databases.

When a transaction pursuant to the loyalty program is conducted, account identification information is read from the card 106 by the reader 104 and provided to the processing terminal 102 (or directly to server system 108). When a loyalty program award is authorized, the transaction information associated with the customer identification information is, in one embodiment, forwarded to central server system 108 for recording therein and manipulation thereby. The session information, which may also be recorded in card or similar medium 106, may also include transaction particulars, such as time and date of transaction, value of transaction, location of transaction, merchant personnel associated with the transaction, processing terminal identification information, transaction-associated discounts such as coupons, and so forth.

Pursuant to the rewards program, each transaction is awarded a value that is set by the merchant. The merchant may assign a point system to transactions, such that for each dollar spent by a customer, the merchant awards that customer an equal number of points, or alternatively some fraction or multiple thereof. Points are accumulated for redemption by the customer when merchant-determined thresholds are reached. Redemption can be in any form, such as cash back to the customer, a discount for the customer in subsequent transactions, gift certificates, store credit, or complimentary merchandise or services, or any combination of these. It may be that a store credit (reward credit) is earned and is added back onto the card and tracked for each merchant. Typically, once a customer credit or award is redeemed, the value of that credit or award is deducted from the customer's account as said account is maintained in central server system 108.

In addition to the core loyalty program, a referral loyalty program can be used to augment the customer base and provide additional incentivization to customers and revenues to merchants. According to the referral-based supplementary program, some or all customers who participate in the core program are rewarded for referring additional customers to one or more participating merchants. The referring customers will be referred to herein as the primary customers. The referred customers will be referred to herein as the secondary customers.

Primary customers who choose to participate in the referral-based loyalty program can be assigned a referral account indicator, which can be their telephone number or other identification number, and which can be associated with a secondary card 112. The referral account indicator can also merely be their original account number. The assignment can be performed during the visit to the merchant, or through a website interaction as detailed below, or via mail after requesting them from the merchant or online through the Internet. The secondary cards 112 are linked to the primary customer's account for proper attribution. The linking can be performed in any number of ways. In the case of magnetic-strip bearing cards, for instance, the primary card can first be swiped, followed by the swiping of the secondary card (or vice versa), and a linking process can be performed electronically at the terminal 102a and/or at the server 108. Other ways of linking the primary card to the secondary card(s) are contemplated, including but not limited to manual entry of some identifying information on the cards to associate the accounts involved with each other, thereby obviating the need for the physical presence of the cards. Linking can be by way of the Internet, telephone system, a website, SMS (texting), and so on, and may be performed by the merchant or under the merchant's direction. The linking information can be card numbers, customer telephone numbers, merchant identification information, account numbers, referral numbers, or the like, or any combination of these, and may be selected at the discretion of the merchant and/or the customer and/or program administrator.

The secondary cards 112 are intended to be distributed by the primary customer to secondary customers, which the primary customer can select for example from a pool of professional or personal acquaintances, or customer lists, or the like. The secondary cards, like the primary cards, are associated with customer accounts and can be used to obtain benefits, such as rewards as discussed above, when business is transacted with the merchant. The rewards may match the rewards received by the primary customers using their primary cards, although this is not a requirement and less or more benefits can be awarded to the secondary customers when they use their secondary cards. In addition, in order to incentivize the primary customer to distribute secondary cards, the primary customer can be rewarded for patronization of the promoted merchant (which may or may not be the originating merchant) by the secondary customers. For instance, in the system 100 of FIG. 1, each time a secondary card 112 is swiped through a terminal 104, not only does the secondary customer receive credit for the transaction (and any commensurate reward), but also the primary customer. The reward to the secondary customer can be in any one or more of the manners described above. The reward to the primary customer can also be in any one or more of the manners described above. Thus data storage device 114 can be used for storing information relating to one or both primary and secondary accounts, associated respectively with the primary and secondary customers. It can similarly store merchant accounts. Central server system 108 maintains primary and secondary customer accounts, identified by unique account numbers that can be customer telephone numbers. These accounts can be linked one another as necessary. In addition, central server system 108 can maintain merchant accounts to which various primary and/or secondary customer accounts can also be linked as necessary. The merchant accounts would also have their own unique identifiers and other information necessary to implement the awards program. Account information storage can be effected in database 114, which can store merchant and customer accounts, or which can be dedicated to primary, secondary or merchant accounts, with other databases (not shown) being provided for other accounts. In addition, additional servers (not shown) can be provided to implement retrieval and servicing of the various additional dedicated databases.

Considering a specific example, the core loyalty program may allow the primary customer to receive a free meal every tenth visit to a merchant's restaurant. In addition, in accordance with the referral-based supplementary program, the primary customer can receive a free meal every twentieth visit that the secondary customer makes to the merchant's restaurant, while the secondary customer can receive a free meal every tenth, fifteenth, or twentieth visit. Of course the rewards to the primary customer from his/her own patronization do not have to be the same as those from the patronization by the secondary customer. Following the same example, the primary customer can receive a free meal every tenth visit he/she makes to the merchant's restaurant, but can receive a $5.00 credit every twentieth visit by the secondary customer, or for every $100.00 the secondary customer spends (that is, a 5% cash back reward), and so on. The numbers are of course examples only, and any proportion (or percentage) is contemplated. In addition, as alluded to above, different merchants can be involved, depending on the promotion program. Thus while secondary cards were obtained by the primary customer at a first merchant, the cards can be for the purpose of promoting a second merchant whose patronization is to be incentivized, based on an agreement between the two merchants in a partnership arrangement for instance.

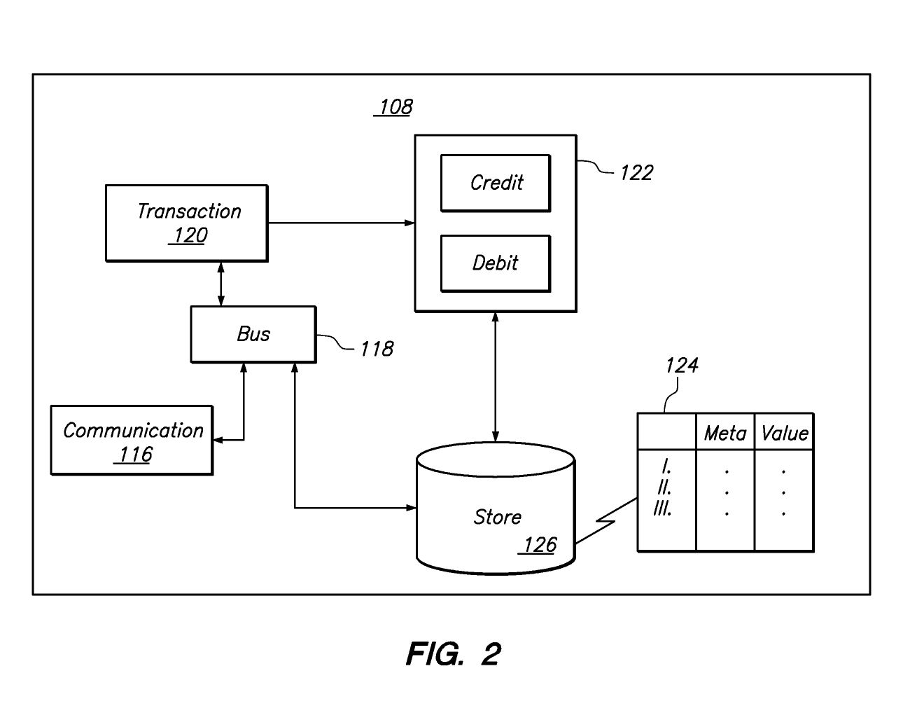

FIG. 2 is a block diagram showing details of a server system 108, which includes various modules configured to perform the tasks recited herein. It will be appreciated that the functionalities ascribed to these modules may overlap, and some modules may be dispensed with altogether. Server system 108 includes a communication module 116 for effecting communication with other devices, for example through a wired or wireless network connection (not shown) or the like. Communication module 116 is coupled to other modules by way of a bus 118. Among these other modules is a transaction module 120 determines the transaction being conducted (sale of an article or service, refund, etc.) and the particulars of that transaction, such as the customer and/or merchant accounts, if any, associated therewith, and so on. Based on the determination, a tabulation module 122 is notified and proceeds to credit and/or debit the account(s) involved. Account information 124, including meta data identifying the accounts different accounts I., II., III., etc. and various characteristics thereof, and actual account values (amount of credits, rewards, etc.), is retained in data store 126 for access and manipulation as necessary.

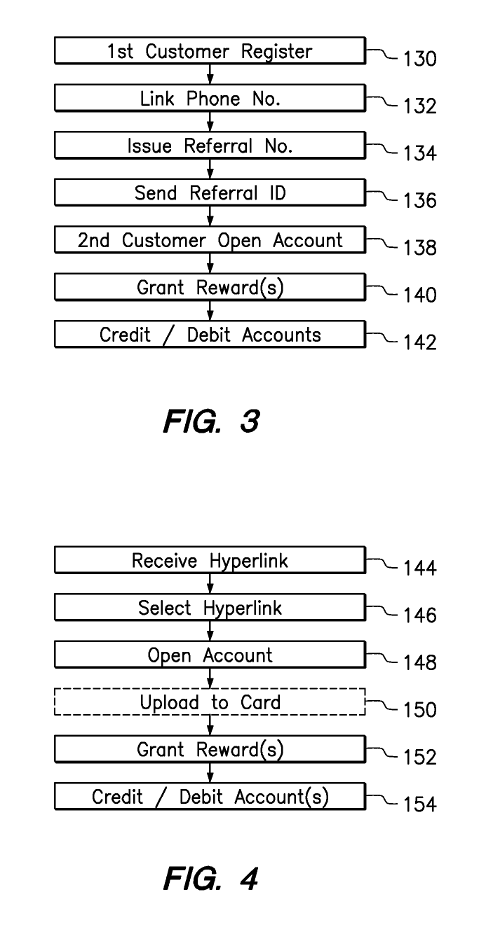

One example approach for implementing a loyalty program, described with reference to FIG. 3, is as follows:
1) The primary customer's primary rewards card, which has a card number, is registered (130), with the merchant and a primary account is associated with the primary customer.
2) Upon registration, the primary customer has the option to link his/her telephone number (132) to the card number of the primary card and account.
3) Once the card and account are registered, the primary customer is issued a referral ID number (134).
4) The primary customer can then send (136) the referral ID number/card number or phone number via e-mail or telephone or SMS text message or in any other manner to a potential secondary customer.
5) The secondary customer who receives the ID or card number or phone number etc. can open an account (138) with the merchant and provide ID or referral information relating to the primary customer account to the merchant, and the merchant can link the two accounts, even if the primary card is not physically present.
6) Rewards are granted (140) as a function of the transaction, and subsequent transactions, in accordance with the supplementary rewards program, to one and/or both the primary and secondary customers as described above.
7) When rewards are awarded or redeemed, primary and/or secondary accounts are appropriately credited or debited, or otherwise modified to reflect same (142).

Another, electronic automated example approach, described with reference to FIG. 4, is as follows:
a. The secondary customer receives a hyperlink (144) from the primary customer, for example via email, SMS text, website, or the like. Attribution information is associated with the hypertext, such that the primary customer (and/or his account) who initiated the referral can be identified and credited as appropriate.
b. The hyperlink is selected (146) by the secondary customer, directing the secondary customer to an order page hosted by or on behalf of the merchant. Attribution integrity is maintained.
c. The secondary customer opens an account (148) with the merchant, which account is linked in some manner to that of the primary customer.
d. Optionally, the relevant account information, possibly including information relating to the account of the primary customer, is uploaded onto a physical card 112 (150), which is mailed to the secondary customer, or picked up by him/her at the merchant or other location.
e. Rewards are granted (152) as a function of the transaction, and subsequent transactions, in accordance with the supplementary rewards program, to one and/or both the primary and secondary customers as described above.
f. When rewards are awarded or redeemed, primary and/or secondary accounts are appropriately credited or debited, or otherwise modified to reflect same (154).

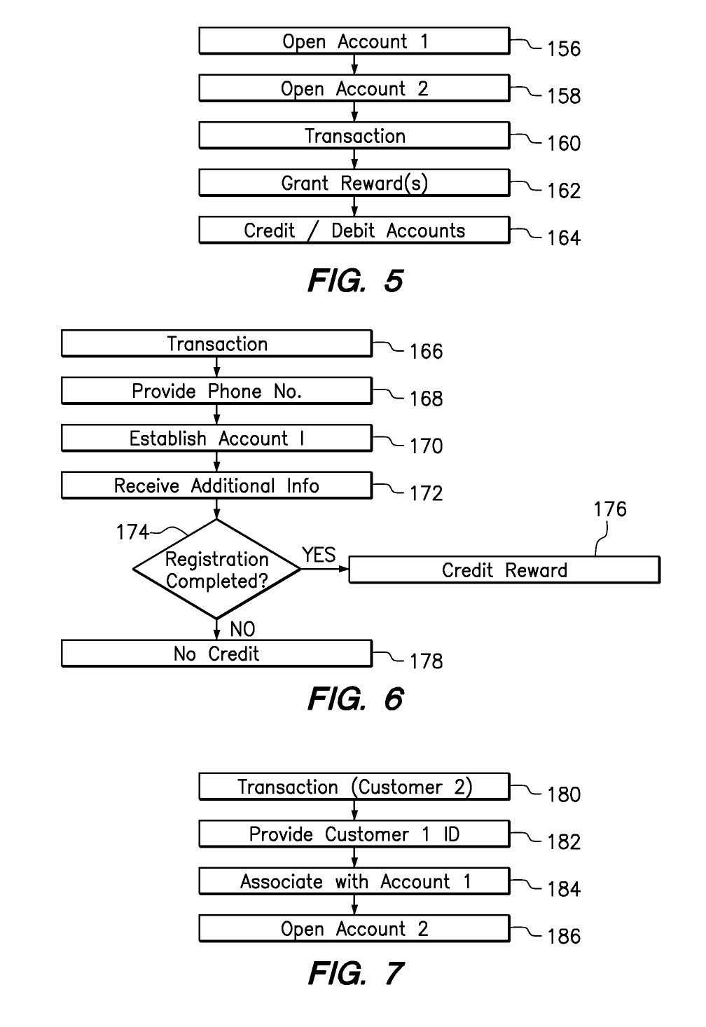

It is also contemplated to dispense with physical cards 106 and/or 112 altogether, for either the primary customer, secondary customer, or both. One such approach, described with reference to FIG. 5, is as follows:
a. The primary customer signs up for the supplementary program in person at the merchant location or the like, or through an online interaction, for example by visiting a merchant website. An account is opened (156) and an account number is assigned for the primary customer. The account number may be the primary customer's telephone number, for example.
b. Subsequently, that telephone number can be used by a referred secondary customer opening a secondary customer account (158) linked to the primary customer. An example can be through receipt of a hyperlink sent to the secondary customer from the primary customer or merchant or other source, which hyperlink includes attribution information, and which directs the secondary customer to an order page of the merchant as described above; or through affirmative action taken by the secondary customer such as his/her visiting the merchant or other location or navigating to the merchant's website on their own, opening an account with the merchant, and making reference to the primary customer's account by for example entering the primary customer's telephone number or account number when prompted or requested. The account opened by the secondary customer can be identified by the secondary customer's telephone number for example.
c. The secondary customer undertakes a transaction (160) with the merchant, live or over the Internet for example, proffering his/her own account number (telephone number) and/or that of the primary customer linked thereto.
d. Rewards are granted (162) as a function of the transaction, and subsequent transactions, in accordance with the supplementary rewards program, to one and/or both the primary and secondary customers as described above.
e. When rewards are awarded or redeemed, primary and/or secondary accounts are appropriately credited or debited, or otherwise modified to reflect same (164).

A variation on the above, described with reference to FIG. 6, can be as follows:
1) Primary customer conducts a transaction at the merchant premises (166)
2) Primary customer provides his/her telephone number to merchant (168).
3) Merchant retains the transaction particulars (amount, etc.) and the telephone number, and establishes a primary customer account (170) and associates same with the telephone number.
4) Primary customer receives information (172), for example a URL (uniform resource locator) printed on the receipt or in a brochure, instructing primary customer to complete registration (174) for an account online and receive a reward, which is only credited (176), as a function of the transaction, upon completion of the registration process and commensurate activation of the account. No credit (178) is given if the registration is not completed.

Secondary customer linking can be implemented, with reference to FIG. 7, as follows:
1) Secondary customer conducts a transaction (180) at the merchant premises.
2) Secondary customer provides his telephone number and the telephone number (or similar account-identifying referral information) of the primary customer (182).
3) Merchant associates (184) the account of the primary customer with the secondary customer.
4) Merchant can then implement opening of secondary customer (186) account linked to primary customer account, and provides rewards accordingly; or secondary customer receives information, for example a URL (uniform resource locator) printed on the receipt or in a brochure, instructing primary customer to complete registration for an account online and receive a reward, which is only credited, as a function of the transaction, upon completion of the registration process and commensurate activation of the account.

It is also contemplated that the referral-based supplementary program can be extended to a third level and beyond. In the third level case, one or more of the secondary customers can be linked with third level cards or accounts that they in turn can distribute, for example to a pool of their own professional or personal acquaintances. Rewards then inure to the distributing secondary customer, and, possibly, to the original primary customer, in addition to the third level customer, in any manner determined by agreement with the merchant.

It is also contemplated that the accounts and rewards are tracked by a merchant process running on a merchant computer. This computer can be server 108. Alternatively, server 108 may belong to or be administered by a third party provider that administers multiple rewards programs for multiple merchants, either segregating them or linking them as desired. A linked type of approach is described in the aforementioned U.S. patent application Ser. No. 11/395,885. Possible roles of the server 108, in addition to those described above, are automating of accounting functions involved, providing limited access to merchants and customers to view their accounts/rewards, and providing notifications of account status, for example via email, SMS “texting,” and so on. One specific notification may involve an email to a primary customer each time a referred secondary customer has received a reward or used the secondary card, or each time the primary customer has been rewarded or incentivized by the secondary customer's usage.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method for implementing a referral-based loyalty program comprising:
establishing a primary account;
establishing a secondary account;
storing information relating to the first and/or second account in a computer memory;
linking the primary and secondary accounts; and
crediting an award to the primary account based on a transaction involving the secondary account.

2. The method of claim 1, further comprising:
crediting an award to the secondary account based on the transaction.

3. The method of claim 1, wherein the award credited to the primary account is different from that credited to the secondary account.

4. The method of claim 1, wherein establishing a primary account and/or establishing a secondary account is conducted online.

5. The method of claim 1, wherein establishing a secondary account comprises:
selecting a hyperlink, said selecting opening an order page; and
filling out the order page.

6. The method of claim 5, wherein the hyperlink includes information identifying the primary account.

7. The method of claim 6, wherein the hyperlink appears on a webpage.

8. The method of claim 6, wherein the hyperlink is received by email.

9. The method of claim 6, wherein the hyperlink is received by SMS text.

10. A method for implementing a referral-based loyalty program comprising:
conducting a first transaction with a primary customer;
establishing a primary customer account using information exchanged during the first transaction;
associating a first reward with the first transaction as a function of the first transaction; and
crediting the first reward to the primary customer account and activating the primary customer account upon completion of a registration process.

11. The method of claim 10, wherein the first transaction is conducted in person.

12. The method of claim 10, wherein the information exchanged is a telephone number.

13. The method of claim 10, further comprising:
conducting a second transaction with a secondary customer;
receiving from the secondary customer information identifying the primary account;
associating a second reward with the second transaction as a function of the second transaction; and
crediting the second reward to the secondary customer account and activating the secondary customer account upon completion of a registration process.

14. The method of claim 13, further comprising:
associating a third reward with the second transaction as a function of the second transaction; and
crediting the third reward to the primary customer account.

15. A server system for implementing a loyalty program, the server system comprising:
a data store configured to store account information relating to a primary customer account associated with the primary customer;
a transaction module configured to track a transaction between a secondary customer and a merchant; and
a tabulation module configured to credit and/or debit the primary customer account with a first reward as a function of the transaction based on information identifying the primary customer account provided by the secondary customer.

16. The server of claim 15, wherein the information identifying the primary customer account is provided electronically.

17. The server of claim 15, wherein the tabulation module is configured to credit and/or debit a secondary customer account associated with the secondary customer with a second reward as a function of the transaction.

18. The server of claim 17, wherein the first reward is different from the second reward.

19. The server of claim 15, wherein the reward is based on transaction value.

20. The server of claim 15, wherein the first reward is based on transaction time.

21. The method of claim 1, further comprising:
establishing a third account;
linking the third account to the first and/or second accounts;
crediting an award to the first and/or second accounts based on a transaction involving the third account.
